(19) United States
(12) Patent Application Publication
(10) Pub. No.: US 2017/0349474 A1
(43) Pub. Date: Dec. 7, 2017

(54) METHODS AND APPARATUSES FOR FORMING GLASS TUBING FROM GLASS PREFORMS

(71) Applicant: Corning Incorporated, Corning, NY (US)

(72) Inventors: Martin Wade Allen, Wilmington, NC (US); Laura Beth Cook, Corning, NY (US); Tonia Havewala Fletcher, Big Flats, NY (US); Daniel Warren Hawtof, Corning, NY (US); Paul Anthony Jakobson, Big Flats, NY (US); David John McEnroe, Corning, NY (US); Aniello Mario Palumbo, Painted Post, NY (US)

(73) Assignee: Corning Incorporated, Corning, NY (US)

(21) Appl. No.: 15/616,273

(22) Filed: Jun. 7, 2017

Related U.S. Application Data
(60) Provisional application No. 62/346,832, filed on Jun. 7, 2016.

(51) Int. Cl. C03B 23/07; C03B 23/047

(52) U.S. Cl. CPC C03B 23/07; C03B 23/0476

(57) ABSTRACT

Methods of forming a glass tube are described. In one embodiment, the method includes heating a glass boule to a temperature above a glass transition temperature of the glass boule, drawing the glass tube from the glass boule in a vertically downward direction, and flowing a pressurized gas through a channel of the glass boule as the glass tube is drawn. The glass boule includes an outer surface defining an outer diameter of the glass boule and a channel extending through the glass boule defining an inner diameter of the glass boule. Drawing the glass tube decreases the outer diameter of the glass boule to an outer diameter of the glass tube and flowing the pressurized gas through the channel increases the inner diameter of the glass boule to an inner diameter of the glass tube. Glass boules, glass tubes, and apparatuses for making the same are also described.

### CROSS REFERENCE TO RELATED APPLICATIONS

The present application claims priority to U.S. Provisional Application No. 62/346,832 filed Jun. 7, 2016, entitled, “Methods and Apparatuses for Forming Glass Tubing From Glass Preforms,” the entirety of which is incorporated by reference herein.

### BACKGROUND

### Field

The present specification generally relates to the manufacture of glass tubing and, more particularly, to methods and apparatuses for forming glass tubing from glass preforms.

### Technical Background

Various methods of manufacturing tubes and/or rods of glass are known. Such methods may include drawing molten glass over a bell, which can generate flaws along the interior surface of the glass tube. Additionally, conventional methods may include contacting the exterior surface of the glass with equipment, such as to change the direction of flow of the glass and/or to continue drawing the glass. This contact with the glass can generate flaws along the exterior surface of the glass tube. For example, in these conventional processes, the glass viscosity may allow the forming tooling to impart longitudinal lines (also referred to as “longitudinal paneling lines”) onto the surface of the resulting tubing as the glass flows over the tooling. These longitudinal paneling lines are a series of peaks and valleys on the tube surface from the glass contact with the metal tooling. Other defects, such as seeds, blister, bubbles or inclusions, may result from melting the glass before it is drawn.

Accordingly, alternative methods and apparatuses for forming glass tubing are needed that reduce flaws in the final glass product.

### SUMMARY

According to one embodiment, a method of forming a glass tube includes heating a glass boule to a temperature above a glass transition temperature of the glass boule, drawing the glass tube from the glass boule in a vertically downward direction, and flowing a pressurized gas through a channel of the glass boule as the glass tube is drawn in the vertically downward direction. The glass boule includes an outer surface defining an outer diameter of the glass boule and a channel extending through the glass boule. The channel defines an inner diameter of the glass boule. Drawing the glass tube decreases the outer diameter of the glass boule to an outer diameter of the glass tube and flowing the pressurized gas through the channel increases the inner diameter of the glass boule to an inner diameter of the glass tube.

According to another embodiment, an apparatus for forming a glass tube includes a furnace, a pressurized gas source, at least one pair of pulling rolls, an inner diameter gauge, an outer diameter gauge, and an electronic control unit. The furnace extends in a substantially vertical direction. The pressurized gas source is fluidly coupled to a channel of a glass boule positioned within the furnace with a supply conduit and provides a flow of pressurized gas to the channel. The at least one pair of pulling rolls is positioned downstream of the heating chamber and is configured to engage with the glass tube drawn from the glass boule. The electronic control unit is communicatively coupled to the inner diameter gauge, the outer diameter gauge, the pressurized gas source, and the at least one pair of pulling rolls. The electronic control unit includes a processor and a non-transitory memory storing computer readable and executable instructions which, when executed by the processor, adjust at least one of a speed and a torque of the at least one pair of pulling rolls based on a signal received from the outer diameter gauge and adjusts a flow rate of the pressurized gas provided by the pressurized gas source based on a signal received from the inner diameter gauge.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments of methods and apparatuses for forming glass tubes and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 illustrates a glass boule manufacturing system in accordance with one or more embodiments described herein;

FIG. 2 illustrates a glass boule accordance with one or more embodiments described herein;

FIG. 3 illustrates a glass tube manufacturing device for use in forming a glass tube from a glass boule in accordance with one or more embodiments described herein; and

FIG. 4 illustrates a process for forming a glass tube from a glass boule using the glass tube manufacturing device of FIG. 3 in accordance with one or more embodiments described herein.

### DETAILED DESCRIPTION

Reference will now be made in detail to various embodiments of methods and apparatuses for forming glass boules and for forming glass tubes from the glass boules, examples of which are illustrated in the accompanying drawings. Whenever possible, the same reference numerals will be used throughout the drawings to refer to the same or like parts.

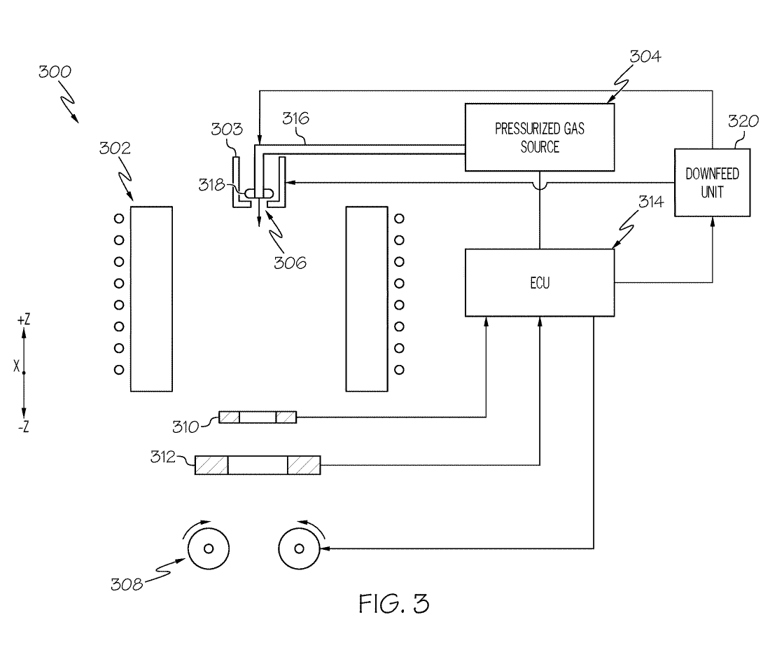

One embodiment of a glass tube manufacturing device is shown in FIG. 3, and is designated generally throughout by the reference numeral 300. The glass tube manufacturing device 300 may generally include a pressurized gas source providing a flow of a pressurized gas to an inner channel of a glass boule positioned within a furnace, a downfeed unit for positioning the glass boule within the furnace and lowering the glass boule into the furnace at a controlled feed rate, at least one pair of pulling rolls positioned downstream of the furnace, an inner diameter gauge, an outer diameter gauge, and an electronic control unit. The glass boule is heated in the furnace to allow the lower portion of the glass boule to decrease in viscosity enabling the glass boule to attenuate down in size. The attenuated portion of the glass boule forms the glass tube which is engaged by at least one pair of pulling rolls below the furnace to draw the glass tube. The electronic control unit is configured to adjust a downfeed rate of the glass boule within the furnace, adjust at least one of a speed and a torque of the at least one pair of pulling rolls based on a signal received from the outer diameter gauge, and adjust a flow rate of the control gas based on a signal received from the inner diameter gauge in order to control the formation of the glass tube. Various embodiments of methods and apparatuses for forming glass tubing from a glass boule will be described herein with specific reference to the appended drawings.

Directional terms as used herein—for example up, down, right, left, front, back, top, bottom, vertical, horizontal—are made only with reference to the figures as drawn and are not intended to imply absolute orientation unless otherwise expressly stated.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

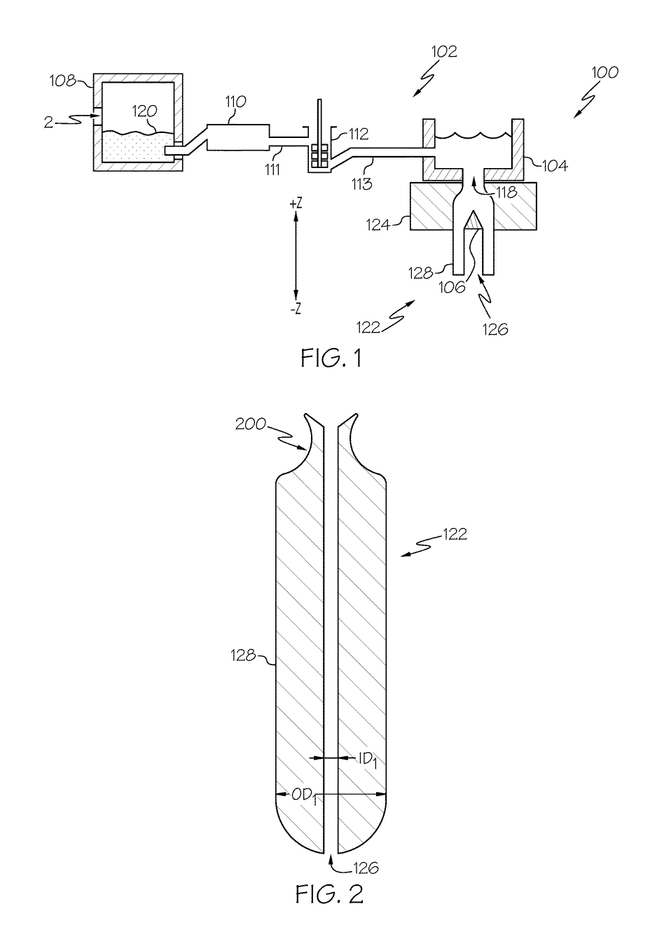

Referring to FIG. 1, an exemplary glass boule manufacturing system 100 for forming a glass boule is schematically depicted. The glass boule manufacturing system 100 generally includes molten glass delivery system 102, a delivery vessel 104 for receiving molten glass, and a mandrel 106.

The molten glass delivery system 102 generally includes a melting vessel 108, a fining vessel 110, and a mixing vessel 112 coupled to the delivery vessel 104 of the glass boule manufacturing system 100.

The delivery vessel 104 may include heating elements (not shown) for heating and/or maintaining the glass in a molten state. The delivery vessel 104 may also contain mixing components (not shown) for further homogenizing the molten glass in the delivery vessel 104. In some embodiments, the delivery vessel 104 may cool and condition the molten glass in order to increase the viscosity of the glass prior to providing the glass to the mandrel 106.

The delivery vessel 104 may include an opening 118 in the bottom thereof. In various embodiments, the opening 118 is circular, but may be oval, elliptical or polygonal, and is sized to permit molten glass 120 to flow through the opening 118 in the delivery vessel 104. The molten glass 120 may flow over the mandrel 106 directly from the opening 118 in the delivery vessel 104 to form a glass boule 122.

Still referring to FIG. 1, in various embodiments, the glass boule manufacturing system 100 further includes an outer mold 124 positioned around the mandrel 106 such that molten glass 120 flows from the delivery vessel 104 between the mandrel 106 and the outer mold 124. The outer mold 124 can have an inner geometry being a non-circular shape corresponding to the opening 118 in the delivery vessel 104. The outside shape of the outer mold 124 can be any shape conducive to the supporting infrastructure.

In operation, the glass batch materials are introduced into the melting vessel 108 as indicated by arrow 2. The glass batch materials are melted in the melting vessel 108 to form molten glass 120. The molten glass 120 flows into the fining vessel 110 which has a high temperature processing area that receives the molten glass 120 from the melting vessel 108. The fining vessel 110 removes bubbles from the molten glass 120. The fining vessel 110 is fluidly coupled to the mixing vessel 112 by a connecting tube 111. That is, molten glass 120 flowing from the fining vessel 110 to the mixing vessel 112 flows through the connecting tube 111. The molten glass 120 is homogenized in the mixing vessel 112, such as by stirring. The mixing vessel 112 is, in turn, fluidly coupled to the delivery vessel 104 through the feed pipe 113.

The molten glass then flows through the opening 118 in the delivery vessel 104 and over the mandrel 106, which forms a channel 126 in the glass boule 122. In embodiments including an outer mold 124, the outer mold 124 shapes an outer surface 128 of the glass boule 122. Together, the mandrel 106 and the outer mold 124 quench the glass, forming a glass boule 122 having an inner channel. Once formed, the glass boule 122 is annealed, which heats the glass boule 122 to a temperature at which residual stresses are relieved before the glass boule 122 is reheated so that it can be drawn into a glass tube 400.

The molten glass 120 may be formed according to known methods of forming molten glass mixtures. Additionally, the particular glass composition components provided to form the molten glass 120 may vary depending on the particular embodiment. In particular, the glass composition components may include, by way of example and not limitation, silica (SiO₂), alumina (Al₂O₃), boron oxide (B₂O₃), alkaline earth oxides (such as MgO, CaO, SrO, or BaO), alkali oxides (including, but not limited to, Na₂O and/or K₂O), and one or more additional oxides or fining agents, such as for example, SnO₂, ZrO₂, ZnO, TiO₂, Cl⁻ or the like. In one specific embodiment, the molten glass mixture may be formed from a glass composition as disclosed in, for example, U.S. Pat. No. 8,551,898. However, it should be understood that other glass compositions for use with the methods and apparatuses described herein are contemplated and possible.

In general, the temperature of the molten glass 120 in the delivery vessel 104 is controlled such that a viscosity of the molten glass 120 at the opening 118 of the delivery vessel 104 is suitable for providing a stable flow of glass from the opening 118. For example, in some embodiments the temperature of the molten glass 120 in the delivery vessel 104 is such that the molten glass mixture has a viscosity of between about 1 kP (kiloPoise) and about 250 kP, between about 25 kP and about 225 kP, or between about 50 kP and about 150 kP to provide a stabilized flow from the delivery vessel 104. The glass compositions used in conjunction with the methods and apparatuses described herein may be limited to glass compositions that yield both an appropriate working viscosity that allows for forming the glass without devitrification and the physical attributes required for the article to be produced. Working viscosity, as used herein, refers to the temperature over which the glass exhibits a viscosity of greater than about 25 kP. However, in certain instances, attributes of the finished article may be desired that cannot be met by glass compositions that are considered drawable. In other words, the desired glass composition may have a liquidus temperature that is sufficiently high that the temperature to prevent devitrification of the molten glass at the opening 118 of the delivery vessel 104 may result in a viscosity of the molten glass at the opening 118 that is below the lower limit of viscosities suitable for drawing. In such embodiments, the mandrel 106 and outer mold 124 may employ active cooling features to remove heat from the molten glass coming out of the opening 118 to increase the viscosity rapidly to overcome crystallization and enable boule formation.

FIG. 2 illustrates an exemplary glass boule 122 that may be formed with the glass boule manufacturing system 100 depicted in FIG. 1. As shown in FIG. 2, the channel 126 of the glass boule 122 defines an inner diameter ID₁ of the glass boule 122 while the outer surface 128 of the glass boule 122 defines an outer diameter OD₁ of the glass boule 122. The inner diameter ID₁ and the outer diameter OD₁ of the glass boule 122 may vary depending on the particular embodiment. For example, in some embodiments, the inner diameter ID₁ of the glass boule 122 is from about 3 mm to about 50 mm and the outer diameter OD₁ of the glass boule 122 is from about 140 mm to about 250 mm. The inner diameter ID₁ of the glass boule 122 may vary depending on the outer diameter OD₁ of the glass boule 122 and may generally range from about 3 mm to about 50 mm, from about 3 mm to about 25 mm, or from about 3 mm to about 5 mm. For example, a glass boule 122 having an outer diameter OD₁ of about 150 mm may have an inner diameter ID₁ of from about 5 mm to about 20 mm. As another example, a glass boule 122 having an outer diameter OD₁ of about 250 mm may have an inner diameter ID₁ of from about 10 mm to about 50 mm. In one particular example, the glass boule 122 has an outer diameter of from about 140 mm to about 160 mm and an inner diameter of from about 6 mm to about 40 mm. In various embodiments, the glass boule 122 may be from about 1 m to about 3 m long or even from about 1.5 m to about 2.5 m long.

In some embodiments, the glass boule 122 can be formed according to alternative methods. For example, in one embodiment, a glass boule 122 is formed without a channel and the channel 126 is then drilled into or otherwise introduced to the glass boule 122, such as by gun drilling or core drilling with a diamond-impregnated metal tip. In some embodiments, shorter lengths of glass (e.g., 12 inches or less) may be drilled and spliced together via flame working to form the glass boule 122.

In other embodiments, a cylinder of glass may be pressed through an extrusion die including a piston to make the glass boule 122. The extrusion die may include a mandrel to form the channel 126 of the glass boule 122. In some embodiments in which the glass is extruded, the temperature of the glass is such that the glass mixture has a viscosity of about 1×10⁵ P (Poise) to about 1×10⁷ P. Alternatively, other methods of forming a glass boule 122 including a channel 126 may be used.

In embodiments, the process of forming the glass boule 122 may result in defects in the glass. Specifically, the channel 126 and/or outer surface 128 may include various defects, such as cracks or scratches. As used herein “defects” refer to bubbles, inclusions, glass particulates, scratches, cracks, airlines, surface impurities, paneling, or any other flaws on the surface of or internal to the glass which reduce the quality of the glass. Such defects may be the result of, for example, irregularities or defects present on the mandrel 106 that interrupt or alter the flow of the molten glass 120. Internal defects such as bubbles and inclusions may result from glass quality coming out of the melting vessel 108. Some bubbles may be drawn down making airlines internal to the wall thickness of the resulting tubing. External defects, such as paneling and blemishes, may result from the molten glass flowing against tooling and being embossed on the surfaces. Defects may also be found in qualities pertaining to geometry, such as areas that deviate from the desired surface shape, such as being out of round, bowing, and the like.

According to various embodiments, the defects on the channel 126 and the defects on the outer surface 128 of the glass boule 122 may be reduced by heating and drawing the inner and outer surfaces to form a glass tube 400 that has fewer defects. Without being bound by theory, when a boule is attenuated to a tube, there is a reduction ratio. The geometry plus any defects that are part of the glass make up are reduced in size by this reduction ratio. Therefore, if the glass boule includes a defect that is 10 mm in size and the reduction ratio is 100, the glass tube 400 includes a defect that is 0.1 mm in size. Accordingly, small defects can be reduced in size such that they become invisible to the human eye. Moreover, the drawing process employed to draw the glass boule 122 into a glass tube 400 may have a flame polishing effect on the surface. For example, if a scratch occurred on the glass boule 122 due to post-processing or handling, it could be “healed” when the glass boule 122 is drawn because the drawing process includes reheating the glass to allow it to flow, thus removing the defect. In particular, the inner diameter ID₁ of the glass boule 122 is increased while the outer diameter OD₁ of the glass boule 122 is decreased to form a glass tube 400 having an inner diameter ID₂ and an outer diameter OD₂.

Moreover, without being bound by theory, formation of a glass tube by drawing the glass tube from a glass boule may result in improved surface quality over glass tubes formed using conventional conversion processes. For example, conventional conversion processes can introduce surface defects due to the various changes in direction and contact points with the surfaces of the glass. By contrast, various methods described herein contact the inner surface of the glass boule with a mandrel during formation and contact the outer surface of the drawn glass tube with pulling rolls, but may not otherwise provide surface contact during manufacturing.

As shown in FIG. 2, in various embodiments, the glass boule 122 includes a handle 200. The handle 200 may be integrally formed with the glass boule 122, such as during extrusion or as the molten glass 120 is let down from the opening 118 in the delivery vessel 104. For example, the molten glass 120 may be drawn faster to form the handle 200, commonly referred to as “necking” the boule. The handle may be, for example, about one meter, about two meters, or even greater in length. Alternatively, the handle 200 may be attached to the glass boule 122 after the glass boule 122 is formed. For example, the handle 200 may be attached using flame work or another suitable technique after the glass boule 122 is annealed or at another point before the glass boule 122 is formed into a glass tube 400. In various embodiments, the handle 200 provides a surface for handling or manipulating the glass boule 122 without contacting the surface of the glass boule 122 itself. Additionally, the handle 200 may act as a conduit for connecting the glass boule 122 to a pressurized gas source to provide pressurized gas to the channel 126 of the glass boule 122, as will be described in greater detail below. For example, the handle 200 may be partly formed at the glass boule 122 with a pre-ground mating joint flame-worked to the handle 200. Without being bound by theory, embodiments in which the glass boule 122 includes a handle may minimize waste and enable all of the glass of the glass boule 122 to be used to form the glass tube 400 without needing to dispose of the end of the glass boule 122.

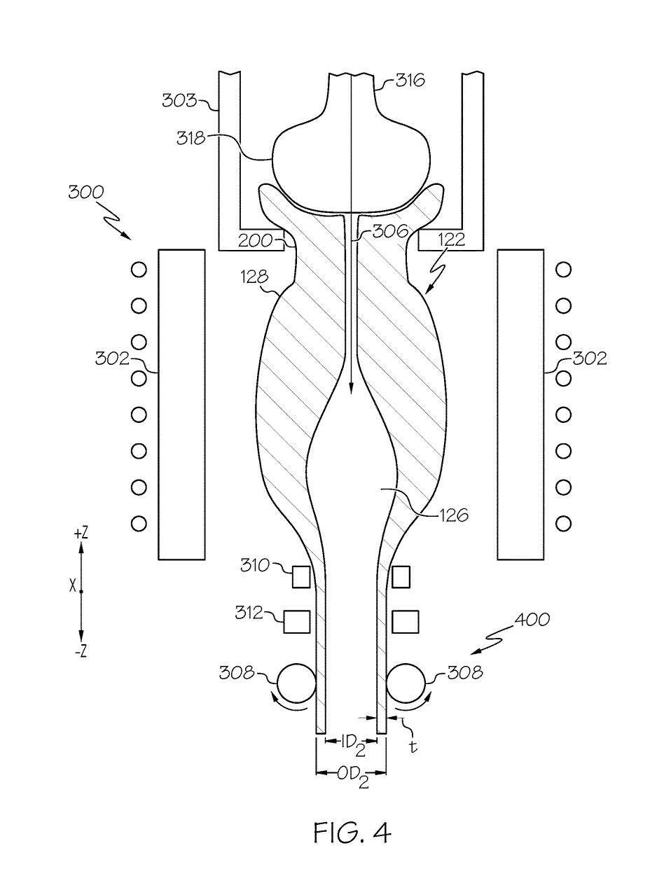

Referring now to FIGS. 3 and 4, after the glass boule 122 has been formed, the glass boule 122 may be inserted in a glass tube manufacturing device 300 to draw a glass tube 400 from the glass boule 122. In embodiments, the glass tube manufacturing device 300 generally includes a furnace 302, a pressurized gas source 304 for supplying a pressurized gas 306, and at least one pair of pulling rolls 308. As used herein, the term “pulling rolls” includes pulling devices including but not limited to tractor belts, pinch wheels, capstan, dual rolls, and the like. The glass tube manufacturing device 300 may further comprise an inner diameter gauge 310, an outer diameter gauge 312, a downfeed unit 320, and an electronic control unit (ECU) 314 for controlling the process of drawing the glass tube 400 from the glass boule 122.

In the embodiments described herein, the furnace 302 may be a tube furnace extending vertically (i.e., in the +/−Z directions of the coordinate axes depicted in FIG. 3). The glass boule 122 (not shown in FIG. 3) may be positioned in the furnace 302. The pressurized gas source 304 may be a pump or other source of pressurized gas, such as a compressed gas cylinder, compressor of the like, that is coupled to the channel 126 of the glass boule 122 with a supply conduit 316. In embodiments, the supply conduit 316 may further include a seal 318 which may be used to seal the supply conduit 316 to the channel 126 of the glass boule 122 when the glass boule 122 is coupled to the pressurized gas source 304. For example, the handle 200 of the glass boule 122 may be coupled to the seal 318 to form a joint. The supply conduit 316, coupled to the channel 126 through the seal 318 and handle 200, provides the pressurized gas 306 from the pressurized gas source 304 to the channel 126. The supply conduit 316 may be in the form of a flexible hose or include at least a portion capable of moving vertically. For example, the supply conduit 316 may include a chuck connected to a screw feed that can be controlled to move in the vertical direction.

The glass tube manufacturing device 300 also includes a handle engagement mechanism 303 to support the handle 200 of the glass boule 122 while it is coupled to the seal 318. In various embodiments, the handle engagement mechanism 303 is open on at least one side to facilitate positioning of the handle 200 within the handle engagement mechanism 303. For example, in various embodiments, the handle 200 of the glass boule 122 may be inserted in the +/−X directions of the coordinate axes depicted in FIGS. 3 and 4 for coupling to the seal 318 and the supply conduit 316.

In embodiments, the pressurized gas source 304 is communicatively coupled to the ECU 314. The ECU 314 may include a processor and a non-transitory memory storing computer readable and executable instructions which, when executed by the processor, regulate the flow rate of the pressurized gas 306 emitted from the pressurized gas source 304. The pressurized gas 306 may be, by way of example and not limitation, air, nitrogen, argon, helium, or another, similar process gas. In some embodiments, the pressurized gas 306 may be an inert gas, while in other embodiments, a forming gas may be employed to influence the chemistry of the surface of the channel 126 while increasing the inner diameter ID₁ of the glass boule 122.

FIG. 3 further depicts a downfeed unit 320 electrically coupled to the ECU 314. The downfeed unit 320 is further coupled to the handle engagement mechanism 303 and the supply conduit 316 and is used to move the glass boule 122 vertically (i.e., in the +/−Z directions of the coordinate axes depicted in FIG. 3) within the furnace 302. Vertical movement of the glass boule 122 within the furnace 302 enables a steady state reduction in size to be maintained in the glass as it is drawn. Accordingly, the handle engagement mechanism 303, the supply conduit 316, the seal 318, the handle 200, and the glass boule 122 are lowered into the furnace 302 until a lower portion of the glass boule 122 reaches the hot zone (not shown) of the furnace 302. For example, the downfeed unit 320 may cause a screw feed associated with the supply conduit 316 and the handle engagement mechanism 303 to turn, lowering the handle engagement mechanism 303 and the supply conduit 316 into the furnace 302, along with the seal 318, the handle 200, and the glass boule 122. The portion of the glass boule 122 in the hot zone of the furnace decreases in viscosity, enabling that portion of the glass boule 122 to attenuate down in size, forming a glass tube 400. As the glass tube 400 is pulled by the pulling rolls 308, the downfeed unit 320 continues to lower the glass boule 122 into the furnace 302. Once the glass boule 122 has been attenuated, the downfeed unit 320 may raise the handle engagement mechanism 303, the handle 200, the seal 318, and the supply conduit 316 vertically out of the furnace 302, enabling the handle 200 to be disconnected from the seal 318 and removed from the handle engagement mechanism 303. In embodiments, the ECU 314 may include a processor and a non-transitory memory storing computer readable and executable instructions which, when executed by the processor, controls a rate at which the downfeed unit 320 adjusts the vertical position of the glass boule 122, the supply conduit 316, the handle engagement mechanism 303, and the seal 318 within the furnace 302.

In embodiments, the at least one pair of pulling rolls 308 are positioned downstream of the furnace 302 and engage with a portion of the outer surface glass tube 400. The pulling rolls 308 may be actively driven, such as by a motor (not shown) electrically coupled to the ECU 314. In embodiments, the ECU 314 may include a processor and a non-transitory memory storing computer readable and executable instructions which, when executed by the processor, control the rotation of the pulling rolls 308 (i.e., the torque and/or speed of the pulling rolls), and thus, the linear draw speed.

In some embodiments, a cooling fluid is provided to cool the glass tube 400. For example, in embodiments in which the glass tube 400 has a large outer diameter OD₂ and thick wall, it may be desirable to cool the glass tube 400 before contacting the glass tube 400 with the pulling rolls 308. The cooling may, for example, decrease the temperature of the glass tube 400 to reduce or eliminate damage to the pulling rolls 308 that can result from a glass tube that is too hot. The cooling fluid may be, for example, an inert gas or a fluid with a temperature sufficient to decrease the temperature of the glass tube 400. The cooling fluid may reduce the temperature of the glass tube 400 to below about 300° C., below about 200° C., or below about 100° C.

Still referring to FIG. 3, the inner diameter gauge 310 and the outer diameter gauge 312 may be positioned downstream of the furnace 302 and are used to measure the inner diameter and outer diameter, respectively, of the glass tube 400 drawn from the glass boule 122 with the glass tube manufacturing device 300. In various embodiments, the inner diameter gauge 310 and the outer diameter gauge 312 may be laser-based or visual-based measurement systems such that the inner diameter may be measured through the wall of the glass boule 122. For example a visual-based inspection system may be employed to measure the inner diameter and outer diameter of the glass tube 400. In particular embodiments, the refractive index of the glass may be employed to reduce or even eliminate lensing effects from the radius of curvature of the glass which may otherwise distort the measurement. In embodiments, the inner diameter gauge 310 may be positioned external to the glass tube 400 and is configured to measure an inner diameter of the glass tube 400 when the supply conduit 316 is coupled to the glass boule 122, as will be described in further detail herein. The inner diameter gauge 310 and the outer diameter gauge 312 are communicatively coupled to the ECU 314 and provide the ECU 314 with electrical signals indicative of the inner diameter and outer diameter, respectively, of the glass tube 400 drawn from the glass boule 122 with the glass tube manufacturing device 300.

In embodiments, the computer readable and executable instructions stored in the memory of the ECU 314 may be configured such that, when executed by the processor, the ECU 314 receives signals from the inner diameter gauge 310 and the outer diameter gauge 312 indicative of the inner diameter and outer diameter, respectively, of the glass tube 400 drawn from the glass boule 122 with the glass tube manufacturing device 300. Based on these signals, the ECU 314 adjusts at least one of the flow of pressurized gas 306 emitted from the pressurized gas source 304, the rate at which the glass boule 122 is lowered into the furnace, and the rotation (e.g., the torque and/or speed) of the at least one pair of pulling rolls 308 in order to control the dimensions (e.g., the inner diameter, outer diameter and, hence, the wall thickness) of the glass tube 400 drawn from the glass boule 122, as will be described in further detail herein.

Turning now to FIGS. 3 and 4, in the embodiments described herein, the ECU 314 of the glass tube manufacturing device 300 controls the pressurized gas source 304 in conjunction with the at least one pair of pulling rolls 308 to draw a glass tube 400 from the glass boule 122 in the downstream direction and thereby increase the length of the glass boule 122 while increasing the inner diameter ID₁ of the glass boule 122 and decreasing the outer diameter OD₁ of the glass boule 122, thereby converting the glass boule 122 to a glass tube 400. To start this process, the glass boule 122 is coupled to the supply conduit 316 through the handle 200 and seal 318. The handle 200 and seal 318 are mated such that pressurized gas 306 is emitted into the channel 126. The inner diameter gauge 310 is positioned external to the glass tube 400 below the furnace 302. Thereafter, the glass boule 122 is lowered into the furnace 302 and heated to a temperature above its glass transition temperature T_{g} at which point the glass of the glass boule 122 behaves as a viscous liquid and begins to flow. This temperature generally coincides with the glass having a viscosity from about 100 kP to about 200 kP such that the glass tube may be drawn from the glass boule 122. As the glass begins to flow from the glass boule 122 in the downstream direction, thereby forming a glass tube 400, the glass tube 400 is directed by the outer diameter gauge 312 and between the at least one pair of pulling rolls 308 such that the pulling rolls 308 contact and engage the outer surface of the glass tube 400 and draw the glass in the downstream direction.

It should be understood that the at least one pair of pulling rolls 308 are located downstream of the furnace 302 a sufficient distance to allow the glass to cool below the glass transition temperature and solidify prior to engaging with the pulling rolls 308 so as to avoid damage to the pulling rolls 308. More specifically, the at least one pair of pulling rolls 308 is positioned to contact the outer surface of the glass tube 400 at a point at which the temperature of the glass tube 400 is below a glass transition temperature T_{g} of the glass tube 400 and the glass boule 122. At temperatures below the glass transition temperature T_{g}, the glass tube 400 behaves like an elastic solid which may be mechanically manipulated, such as with the pulling rolls 308, without damaging the pulling rolls 308.

Although the glass transition temperature T_{g} varies with the particular glass composition forming the glass boule 122, and thus the glass tube 400, the glass transition temperature T_{g} typically ranges from about 1200° C. to about 450° C. Accordingly, in various embodiments, the pulling rolls 308 are positioned to contact the outer surface of the glass tube 400 at a point at which the temperature of the glass tube 400 is about 50° C. below the glass transition temperature T_{g}, about 100° C. below the glass transition temperature T_{g}, about 200° C. below the glass transition temperature T_{g}, about 300° C. below the glass transition temperature T_{g}, or about 400° C. below the glass transition temperature T_{g}. In some embodiments, the pulling rolls 308 contact the glass tube 400 at a point at which the glass tube has a temperature of between about 50° C. and about 250° C. Without being bound by theory, when the pulling rolls 308 are positioned to contact the glass tube 400 when the glass tube 400 is at a temperature below the glass transition temperature T_{g}, the pulling rolls 308 may draw the glass tube 400 (including the defects already present in the outer surface 128 of the glass boule 122) and heal at least some of the surface defects and/or geometry non-uniformities through heating without introducing additional defects in the outer surface of the glass tube 400, thereby forming a glass tube 400 having fewer defects than the glass boule 122 from which it was formed.

As the glass tube 400 is drawn in the downstream direction, the pressurized gas source 304 directs the pressurized gas 306 through the supply conduit 316 and into the channel 126 of the glass boule 122. The pressurized gas 306 pressurizes the channel 126 of the glass boule 122 (which is now plastically deformable due to the heating in the furnace 302) and increases the inner diameter ID₁ of the glass boule 122 to an inner diameter ID₂ of the glass tube 400 by virtue of the applied pressure and the increased plasticity of the glass due to heating.

The increase in the inner diameter ID can be controlled by, for example, controlling the pressure of the pressurized gas 306 supplied to the channel 126 of the glass boule 122. In embodiments, the pressure of the pressurized gas 306 emitted by the pressurized gas source 304 is regulated by the ECU 314 based on signals received from the inner diameter gauge 310. For example, the ECU 314 may receive signals from the inner diameter gauge 310 indicative of the inner diameter ID₂ of the glass tube 400 being formed. The processor of the ECU 314 may compare the measured inner diameter ID₂ of the glass tube with a target ID value stored in the memory of the ECU 314. When the processor determines that the target ID value is greater than the measured value of the inner diameter ID₂, the processor of the ECU 314 sends a control signal to the pressurized gas source 304 which increases the flow rate of pressurized gas 306 emitted from the pressurized gas source 304 thereby increasing the inner diameter ID₂ of the glass tube 400. Alternatively, when the processor determines that the target ID value is less than the measured value of the inner diameter ID₂, the processor of the ECU 314 sends a control signal to the pressurized gas source 304 which decreases the flow rate of pressurized gas 306 emitted from the pressurized gas source 304 thereby decreasing the inner diameter ID₂ of the glass tube 400. Thus, the inner diameter gauge 310 and the ECU 314 form a feedback loop with the pressurized gas source 304 to control the inner diameter ID₂ of the glass tube 400 by measuring the inner diameter ID₂ of the glass tube 400 and adjusting the pressure of the pressurized gas 306 based on the inner diameter ID₂ of the glass tube 400. In various embodiments, the pressurized gas 306 is directed through the inner diameter ID₁ of the glass boule 122 at a pressure of between about 5 kPa and about 50 kPa, between about 7.5 kPa and about 25 kPa, or between about 10 kPa and about 15 kPa.

As the pressurized gas 306 is directed into the channel 126 of the glass boule 122, the pulling rolls 308 pull the glass tube 400 in the downward vertical direction (i.e., in the −Z direction of the coordinate axes depicted in FIGS. 3 and 4) by contacting the outer surface of the glass tube 400. In embodiments, the ECU 314 may be employed to control the thickness of the glass tube 400 drawn from the furnace. The thickness of the glass tube 400 may be controlled by controlling the inner diameter ID₂ of the glass tube 400, as described above, and/or controlling the outer diameter OD₂ of the glass tube 400. For example, the decreased viscosity of the glass of the glass boule 122 combined with the drawing force exerted on the glass by the pulling rolls 308 decreases the outer diameter OD₁ of the glass boule 122 to an outer diameter OD₂ of the glass tube 400. The change in the outer diameter OD can be controlled by, for example, controlling the speed and/or torque of the pulling rolls 308. In embodiments, the rotation of the at least one pair of pulling rolls 308 is regulated by the ECU 314 based on signals received from the outer diameter gauge 312. For example, the ECU 314 may receive signals from the outer diameter gauge 312 indicative of the outer diameter OD₂ of the glass tube 400 being formed. The processor of the ECU 314 may compare the measured outer diameter OD₂ of the glass tube 400 with a target OD value stored in the memory of the ECU 314. When the processor determines that the target OD value is greater than the measured value of the outer diameter OD₂, the processor of the ECU 314 sends a control signal to the pulling rolls 308 to decrease the speed and/or torque of the pulling rolls 308 thereby increasing the outer diameter OD₂ of the glass tube 400. Alternatively, when the processor determines that the target OD value is less than the measured value of the outer diameter OD₂, the processor of the ECU 314 sends a control signal to the pulling rolls 308 to increase the speed and/or torque of the pulling rolls 308 thereby increasing the outer diameter OD₂ of the glass tube 400. Thus, the outer diameter gauge 312 and the ECU 314 can form a feedback loop with the pulling rolls 308 to control the outer diameter OD₂ of the glass tube 400 by measuring the outer diameter OD₂ of the glass tube 400 and adjusting the speed and/or torque of the pulling rolls 308 based on the outer diameter OD₂ of the glass tube 400. In various embodiments, the pulling rolls 308 are turned at a rate that corresponds to a linear draw speed of between about 0.1 m/minute and about 60 m/minute, between about 1 m/minute and about 30 m/minute, or between about 10 m/minute and about 20 m/minute. In particular embodiments, the pulling rolls 308 contact the glass at a point at which the glass temperature is below about 200° C.

In one example, a glass tube was drawn from a glass boule having a 90 mm outer diameter OD₁ and having a 10 mm inner diameter ID₁ at a viscosity of about 50 kP and no pressure. The glass boule was fed into the furnace at a downfeed rate of 25 mm/min and the temperature of the furnace was about 930° C. The resultant glass tube had a 3:1 reduction ratio and resulted in a tube having a 30 mm outer diameter OD₂ with a 3.33 mm inner diameter ID₂. However, when pressurized gas was applied to the channel of the glass boule at a pressure of about 1.5 psi, the inner diameter ID₂ increased to about 25 mm. Along with the increase in the inner diameter, the outer diameter OD₂ of the tube also increased. Accordingly, to reduce the outer diameter OD₂ of the tube back to 30 mm, the speed of the pulling rolls was increased to produce a linear draw speed of 1 m/min to yield a glass tube having a 30 mm outer diameter OD₂ and having a 25 mm inner diameter ID₂.

In various embodiments, as the glass tube 400 is drawn from the glass boule 122, the ECU 314 provides feedback to the downfeed unit 320 which, in turn, causes the downfeed unit 320 to lower the handle 200, and thus the glass boule 122, further down into the furnace 302. In some embodiments, the ECU 314 can cause the downfeed unit 320 to lower the handle 200 and the glass boule 122 into the hot zone of the furnace 302 at a particular feed rate. The feed rate may be selected based on the desired inner diameter and outer diameter of the glass tube 400 and the temperature of the furnace 302. Without being bound by theory, a fast feed rate results in a shorter glass residency time in the hot zone of the furnace 302, which may enable a higher viscosity of the glass. Therefore, in some embodiments, the downfeed rate may be adjusted in order to control the outer diameter OD₂ and/or inner diameter ID₂ of the glass tube 400.

According to various embodiments, the glass tube 400 has an outer diameter OD₂ that is less than the outer diameter OD₁ of the glass boule 122 and an inner diameter ID₂ that is greater than the inner diameter ID₁ of the glass boule 122. The inner diameter ID₂ and the outer diameter OD₂ of the glass tube 400 may vary depending on the particular embodiment. For example, in various embodiments, the inner diameter ID₂ of the glass tube 400 is from about 0.5 mm to about 70 mm and the outer diameter OD₂ of the glass tube 400 is from about 1 mm to about 80 mm. The inner diameter ID₂ may be from about 0.75 mm to about 50 mm, from about 0.8 mm to about 40 mm, or from about 1 mm to about 35 mm. The outer diameter OD₂ may be from about 1.25 mm to about 65 mm, from about 1.5 mm to about 45 mm or from about 2 mm to about 40 mm. In various embodiments, the resultant glass tube 400 has a wall that has a thickness t of from about 0.100 mm to about 10 mm or from about 0.2 mm to about 5 mm. In some embodiments, the glass tube may have an inner diameter ID₂ of from about 1.6 mm to about 7 mm, an outer diameter OD₂ of from about 2 mm to about 10 mm and a wall thickness of from about 0.2 mm to about 1.5 mm or an inner diameter ID₂ of from about 1.8 mm to about 4 mm, an outer diameter OD₂ of from about 2 mm to about 5 mm and a wall thickness of from about 0.100 mm to about 0.5 mm. In one particular embodiment, the glass tube 400 has an inner diameter ID₂ of about 2.4 mm, an outer diameter OD₂ of about 3 mm and a wall thickness of about 0.3 mm.

Larger glass tubes may also be made according to the methods provided herein. In one embodiment, the glass tube may have an inner diameter ID₂ of about 8 mm, an outer diameter OD₂ of 10 mm and a wall thickness of about 1 mm. In another embodiment, the glass tube may have an inner diameter ID₂ of about 14.35 mm, an outer diameter OD₂ of about 16.75 mm and a wall thickness of about 1.2 mm. In yet another embodiment, the glass tube may have an inner diameter ID₂ of about 20 mm, an outer diameter OD₂ of about 25 mm and a wall thickness of about 2.5 mm. In other embodiments, the glass tube may have an inner diameter ID₂ of about 36 mm, an outer diameter OD₂ of about 40 mm and a wall thickness of about 2 mm or an inner diameter ID₂ of about 54 mm, an outer diameter OD₂ of about 60 mm and a wall thickness of about 3 mm. In still another embodiment, the glass tube may have an inner diameter ID₂ of about 62 mm, an outer diameter OD₂ of about 70 mm and a wall thickness of about 4 mm. Accordingly, various embodiments may provide for glass tubes of various sizes and with various wall thicknesses.

In one embodiment a profiled glass tube 400 can be formed from a glass boule 122 having a non-circular outer geometry. The glass boule formed from an outer mold 124 having an inner geometry that is non-circular in shape, such as oval, elliptical or polygonal, and corresponds to the opening 118 in the delivery vessel 104. The profiled glass tube 400 drawn from the glass boule 122 may maintain its outer shape when the viscosity of the drawn tube is kept high enough (e.g., >50 kP or >80 kP) to prevent surface tension of the glass to distort the outside shape of tube 400. Active cooling can be applied to the outside of the glass boule 122 while the glass boule 122 is attenuated down and transitioned to the glass tube 400 just below the draw furnace 302 Tt maintain the outside shape of tube 400 while pressurizing the inside diameter 126 of boule 122.

The glass tube 400 may be cut using a tube cutter and/or otherwise converted into another product. For example, the glass tube 400 may be converted into one or more syringes, cartridges, or vials. Depending on the particular embodiment and desired product, the glass tube 400 may be converted before being cooled using the cooling fluid. Coatings or other processing, such as ion exchange, polishing, or the like, may be performed on the resulting product depending on the particular embodiment.

Accordingly, various embodiments described herein may be employed to form glass tubes, glass syringes, glass cartridges, glass vials, and the like from glass boules. Various embodiments enable defects in the surface of the glass boule to be drawn during formation of the glass tube, thereby reducing the amount of defects in the glass tube (and thus in the glass syringes, cartridges, and vials formed therefrom).

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of forming a glass tube, the method comprising:
heating a glass boule to a temperature above a glass transition temperature of the glass boule, the glass boule comprising an outer surface defining an outer diameter of the glass boule and a channel extending through the glass boule, the channel defining an inner diameter of the glass boule;
drawing the glass tube from the glass boule in a vertically downward direction, thereby decreasing the outer diameter of the glass boule to an outer diameter of the glass tube; and
flowing a pressurized gas through the channel of the glass boule as the glass boule is drawn in the vertically downward direction thereby increasing the inner diameter of the glass boule to an inner diameter of the glass tube.

2. The method of claim 1, further comprising forming the glass boule by directing molten glass over a mandrel.

3. The method of claim 1, wherein the drawing the glass boule comprises engaging at least one pair of pulling rolls with an outer surface of the glass tube defining the outer diameter of the glass tube.

4. The method of claim 3, wherein the at least one pair of pulling rolls are engaged with a portion of the outer surface of the glass tube at a temperature below the glass transition temperature of the glass boule.

5. The method of claim 1, further comprising attaching a handle to the glass boule prior to drawing the glass tube.

6. The method of claim 5, wherein attaching the handle comprises integrally forming the handle with the glass boule.

7. The method of claim 1, further comprising:
measuring the inner diameter of the glass tube; and
adjusting a pressure of the pressurized gas based on the inner diameter measured for the glass tube.

8. The method of claim 1, further comprising:
measuring the outer diameter of the glass tube; and
adjusting a rate at which the glass tube is drawn in a downward vertical direction based on the outer diameter measured for the glass tube.

9. The method of claim 8, wherein adjusting the rate at which the glass tube is drawn comprises adjusting at least one of a speed and a torque of at least one pair of pulling rolls that contact the glass tube.

10. The method of claim 1, further comprising cooling the glass tube with a cooling fluid before engaging at least one pair of pulling rolls with an outer surface of the glass tube.

11. An apparatus for forming a glass tube, the apparatus comprising:
a furnace extending in a substantially vertical direction;
a pressurized gas source fluidly coupled to a channel of a glass boule positioned within the furnace with a supply conduit, the pressurized gas source providing a flow of pressurized gas to the channel;
at least one pair of pulling rolls positioned downstream of the furnace and configured to engage with the glass tube drawn from the glass boule;
an inner diameter gauge;
an outer diameter gauge; and
an electronic control unit communicatively coupled to the inner diameter gauge, the outer diameter gauge, the pressurized gas source, and the at least one pair of pulling rolls, the electronic control unit comprising a processor and a non-transitory memory storing computer readable and executable instructions which, when executed by the processor:
adjusts at least one of a speed and a torque of the at least one pair of pulling rolls; and
adjusts a flow rate of the pressurized gas provided by the pressurized gas source.

12. The apparatus of claim 11, wherein the at least one pair of pulling rolls are positioned and configured to engage with the glass tube at a temperature below a glass transition temperature of the glass boule.

13. The apparatus of claim 11, wherein the computer readable and executable instruction set, when executed by the processor, adjusts the at least one of a speed and a torque of the at least one pair of pulling rolls based on a signal received from the outer diameter gauge.

14. The apparatus of claim 12, wherein:
the signal received from the outer diameter gauge corresponds to a measured outer diameter for the glass tube; and
the computer readable and executable instruction set, when executed by the processor, compares the measured outer diameter for the glass tube to a target outer diameter value stored in the non-transitory memory.

15. The apparatus of claim 14, wherein the computer readable and executable instruction set, when executed processor, increases at least one of a speed and a torque of the at least one pair of pulling rolls responsive to determining that the measured outer diameter for the glass tube is greater than the target outer diameter value stored in the non-transitory memory.

16. The apparatus of claim 11, wherein the computer readable and executable instruction set, when executed by the processor, adjusts the flow rate of the pressurized gas provided by the pressurized gas source based on a signal received from the inner diameter gauge.

17. The apparatus of claim 16, wherein:
the signal received from the inner diameter gauge corresponds to a measured inner diameter for the glass tube; and
the computer readable and executable instruction set, when executed by the processor, compares the measured inner diameter for the glass tube to a target inner diameter value stored in the non-transitory memory.

18. The apparatus of claim 17, wherein the computer readable and executable instruction set, when executed processor, increases the flow rate of the pressurized gas provided by the pressurized gas source responsive to determining that the measured inner diameter for the glass tube is less than the target inner diameter value stored in the non-transitory memory.

19. The apparatus of claim 18, wherein:
the signal received from the outer diameter gauge corresponds to a measured outer diameter for the glass tube; and
the computer readable and executable instruction set, when executed by the processor, compares the measured outer diameter for the glass tube to a target outer diameter value stored in the non-transitory memory.

20. The apparatus of claim 19, wherein the computer readable and executable instruction set, when executed processor, increases at least one of a speed and a torque of the at least one pair of pulling rolls responsive to determining that the measured outer diameter for the glass tube is greater than the target outer diameter value stored in the non-transitory memory.

21. The apparatus of claim 11, the apparatus further comprising a downfeed unit communicatively coupled to the electronic control unit communicatively, wherein the computer readable and executable instruction set, when executed processor, controls a rate at which the downfeed unit adjusts a vertical position of the glass boule within the furnace.

22. The apparatus of claim 11, wherein the pressurized gas source is fluidly coupled to the channel of the glass boule through a seal that couples with a handle of the glass boule.
